(19) United States
(12) Patent Application Publication
(10) Pub. No.: US 2025/0199879 A1
(43) Pub. Date: Jun. 19, 2025

(54) RIEMANNIAN WORKLOAD PROFILE CHARACTERIZATION SCORING FOR SYSTEM CONFIGURATION RECOMMENDATION

(71) Applicant: Dell Products L.P., Round Rock, TX (US)

(72) Inventors: Isabella Costa Maia, São Paulo (BR); Paulo Abelha Ferreira, Rio de Janeiro (BR); Julia Drummond Noce, Rio de Janeiro (BR); Victor da Cruz Ferreira, Rio de Janeiro (BR); Vinicius Michel Gottin, Rio de Janeiro (BR)

(21) Appl. No.: 18/544,279

(22) Filed: Dec. 18, 2023

(51) Int. Cl. G06F 9/50

(52) U.S. Cl. CPC G06F 9/5083; G06F 9/5027; G06F 2209/5019; G06F 2209/508

(57) ABSTRACT

One example method includes deploying a set of non-degenerate models to a system having a known configuration, where each of the non-degenerate models corresponds to a pair that comprises a system configuration and a workload class, running a workload on the system, collecting telemetry data generated as a result of the running of the workload, assessing the telemetry data with each of the non-degenerate models to generate a respective score for each of the models, identifying, as among the non-degenerate models, which of the non-degenerate models has the best score, and determining, based on the best score, whether or not a change is needed to hardware and/or software of the known configuration of the system.

### FIELD OF THE INVENTION

Embodiments of the present invention generally relate to the pairing of workloads with execution infrastructures. More particularly, at least some embodiments of the invention relate to systems, hardware, software, computer-readable media, and methods, for determining, amongst a finite range of possibilities, an infrastructure best suited to support the execution of a customer workload.

### BACKGROUND

Infrastructure sizing may be an important consideration in pricing, support, and sales. Accurately sizing and configuring systems may be important both in terms of reduction of costs and customer satisfaction. Defining the right infrastructure to support customer needs is often done without knowing with any certainty if the sized infrastructure will satisfy the response-time requirements of the end user applications. Furthermore, the sizing decisions may be made a priori, while changes to the workloads deployed at the actual infrastructure may take place.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of a method, including offline and online stages, for determining workload class changes, according to an embodiment.

FIG. 2 discloses aspects of workload classes and system configuration classes, according to an embodiment.

FIG. 3 discloses various models, generated from a group of executions, collected as a set, according to one embodiment.

FIG. 4 discloses a representation of a deployed system, according to an embodiment.

FIG. 5 discloses an approach for telemetry collection and model scoring, according to an embodiment.

FIG. 6 discloses an example computing entity that is configured to perform any of the disclosed methods, processes, and operations.

### DETAILED DESCRIPTION OF SOME EXAMPLE EMBODIMENTS

Embodiments of the present invention generally relate to the pairing of workloads with execution infrastructures. More particularly, at least some embodiments of the invention relate to systems, hardware, software, computer-readable media, and methods, for determining, amongst a finite range of possibilities, an infrastructure best suited to support the execution of a customer workload.

One example embodiment comprises a method that may assume a known set of workload classes and system configurations. Telemetry data resulting from the execution of workloads, in those classes, on the system configurations may be collected. A Riemannian model, which may be referred to herein simply as a ‘model,’ may then be trained for each pair of (1) a workload, and (2) system configuration on which the workload was, or is being, executed. These Riemannian models may then be deployed with a new system having a given configuration. As a workload is executed on the new system, further telemetry data pertaining to that execution may be collected, and that data evaluated using the Riemannian models. This evaluation of the data may result in the generation of respective scores, which may be normalized, for each of the models. Recalling that each Riemannian model corresponds to a workload class/system configuration pair, a best-scoring Riemannian model, identifying a particular workload class, may be identified. This workload class may then be evaluated to determine if it has changed, relative to the particular workload that is being executed. If the workload class has changed, a corresponding recommendation may be made to modify the system configuration to better match the system configuration to the workload.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, an advantageous aspect of one embodiment is that a system configuration may be identified, for the execution of a workload, that may be better suited in terms of workload performance, relative to a previous system configuration, on which that workload was executed. An embodiment may be relatively lightweight in terms of the demand that it places on a computing infrastructure. Various other advantages of one or more example embodiments will be apparent from this disclosure.

### A. Overview of Aspects of an Example Embodiment

Accurately sizing and configuring execution environments, or systems, for workloads may be an important consideration in operations such as pricing, support, and sales. Thus, an approach for profiling workloads with respect to known system configurations may be desirable, as it may enable provision of a dynamic assessment of the appropriateness of the currently deployed/assigned infrastructure of a customer. Any such approach should be stable, such that it does not signal too-frequent changes to the infrastructure and avoids unnecessary changes if gains in performance are not significant. Such an approach should also be computationally efficient, such as with respect to memory and processing consumption for example, so as not to materially impact the performance of the system itself. Thus, an embodiment may comprise an efficient technique, involving multi-channel anomaly detection, for leveraging the technique characteristics of robustness to noise, and adapting the technique to a workload profiling task.

In more detail, an anomaly detection technique called the “Riemannian Potato” was recently introduced, as disclosed in “A. Barachant, A. Andreev and M. Congedo, ‘The Riemannian Potato: an automatic and adaptive artifact detection method for online experiments using Riemannian geometry.,’ TOBI Workshop IV, 2013” (“Barachant”), which is incorporated herein in its entirety by this reference. This technique may be robust to multiple channels and on capturing a particular telemetry data distribution. This technique may capture a particular distribution well to use that distribution for detecting distribution change whenever the telemetry data starts appearing anomalous to the technique.

One example embodiment may comprise an offline stage, and an online stage. Particularly, in an example offline stage:
determine classes of known workloads and a set of typical configurations for compute/storage arrays, which may be generically referred to herein as “system configuration”;
determine a “Riemannian Potato” model for each pair of typical workload class and system configuration—the model may be generated from telemetry data collected from the system when performing one or more workloads of that class; and
prune degenerate models, ensuring they are separated in the space of channels, that is, features of the telemetry data.

In an example online stage, having deployed all non-degenerate models along with a new system such as, for example, a new storage array deployed at a customer premises:
capturing the current telemetry data of the system deployed;
performing anomaly detection with respect to each Riemannian model individually;
leverage the results of the anomaly detection to assign a score for each Riemannian model; and
deciding, based on the scores obtained currently and in the recent past, that is, the current and the previous window of telemetry data, and offering a recommendation of a change in system configuration to optimize the system performance to match its current workloads.

Thus, an embodiment may possess various useful features and aspects, although none of such features and aspects is necessarily required to be implemented in any embodiment. One such aspect is leveraging a robust method of anomaly detection for workload profiling. As another example, an embodiment may implement a dynamic determination of workload profiling for adjusting aaS (as-as-Service) offerings, which could reflect on flexible consumption or multi-tenancy methods. Further, an embodiment may implement workload profiling that takes place relatively quickly, with a delay corresponding to the predetermined length of anomaly-detection windows. As a final example, an embodiment may implement the orchestration of workload profiling and system configuration recommendations, imposing minimal costs and with negligible computational footprint.

### B. Context for an Example Embodiment

The Riemannian Potato is a time series anomaly detection technique that has been finding applications in many domains, especially in those with noisy data such as, for example, GPS, radar, and electroencephalography. In this method, the signal is split into time windows and transformed into covariance matrices that relate the signal features/channels. These are used as sample data descriptors, although of reduced dimension, compared to the original data, to define a “region of normality” on the covariance space.

Because covariance matrices lie on a Symmetric Positive Definite (SPD(n)) space, using usual straight-line distance metrics such as Euclidean distance can lead to non-admissible covariance matrices, which would have negative eigenvalues and leave the SPD(n) cone. Thus, an embodiment may employ a curve distance metric. Since the SPD(n) space is differentiable, an embodiment may “break down” the neighborhood around each covariance matrix C into a local linearization of that space, referred to as “tangent space,” where a Riemannian metric may then be applied. By choosing a Riemannian metric on each tangent space, an embodiment may readily calculate the distance between covariance matrices following geodesics, that is, the shortest path between two points in a manifold.

The Riemannian Potato method calculates the Riemannian distance of each new sample covariance matrix to a reference matric C̅ and decides, based on a given z-score, if this sample is to be considered anomalous or not. More formally:

Let x(t) be a zero-centered multivariate signal composed of N channels, each representing a different time series. Let xₖ be the k^{th} time-window under consideration such that xₖ=[x₁ₖ, . . . , x_{Nk}]^{T} where xᵢₖ∈ [symbol] ^{T}, i∈1, . . . , N corresponds to k^{th} time-window of the i^{st} channel containing T of its time step values such that xₖ∈ [symbol] [symbol] ^{x} [symbol] . The k^{th} sample covariance matrix of x(t) is given by

$${C}_{k} = \frac{1}{N - 1} {x}_{k} {x}_{k}^{T}$$

with C_{K}∈ [symbol] [symbol] ^{x}

[symbol]

As for illustrating the case for N=2, there would be:

$${C}_{k} = ( \begin{matrix}Var ( {x}_{1 k} ) & Cov ( {x}_{1 k} , {x}_{2 k} ) \\ Cov ( {x}_{2 k} , {x}_{1 k} ) & Var ( {x}_{2 k} )\end{matrix} )$$

The Riemannian metric used in the Riemannian Potato algorithm is the Fisher-Rao metric, which amounts to the following distance value:

$$δ ( \overline{C} , {C}_{k} ) = \sqrt{{\sum }_{n = 1}^{N} {log}^{2} {λ}_{n}}$$

With λₙ being the eigenvalues of C̅⁻¹Cₖ.

Finally, let C̅ be the reference covariance matrix that equals the geometric mean of a training set {C₁, . . . , Cₘ} containing the first m covariance matrices of the signal x(t). A sample covariance matrix Cⱼ, j>m is considered anomalous if the z-score of Cⱼ is greater than a user-defined threshold z, that is:

$$\frac{δ ( \overline{C} , {C}_{j} ) - μ}{σ} > z$$

where μ, σ are the mean and standard deviations of the distance to the reference matrix in the training set.

### C. Detailed Discussion of Aspects of an Example Embodiment

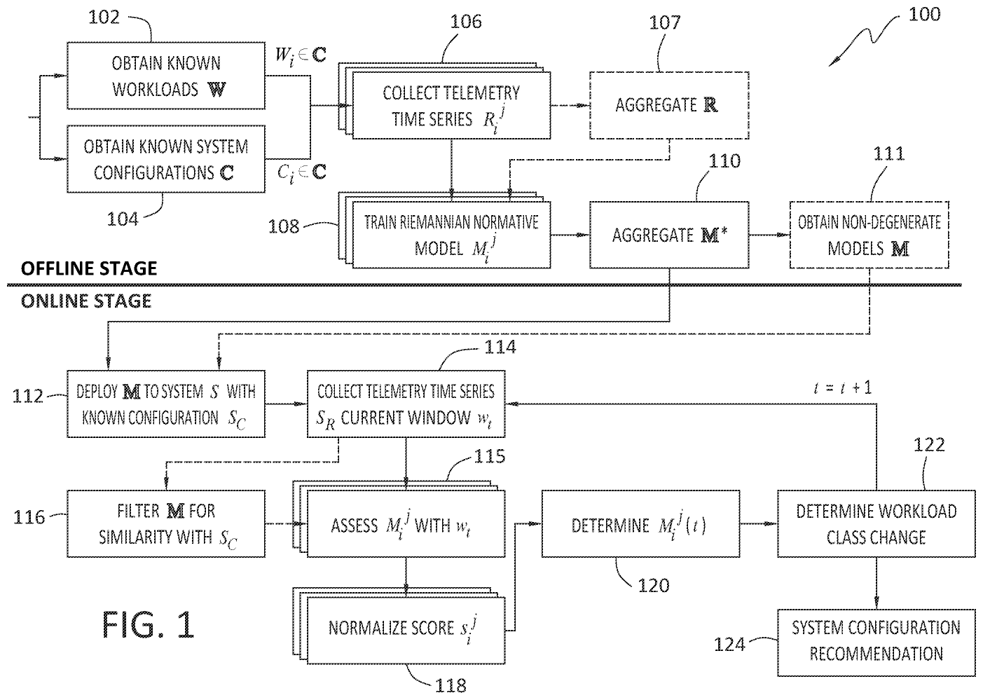

An example embodiment comprises a technique for a workload profiling task. Aspects of one such approach are disclosed in FIG. 1. More specifically, FIG. 1 discloses a method 100 for determining workload class changes; an offline processing stage (top) and an efficient online processing stage (bottom).

As shown in FIG. 1, the method 100 may obtain a known set of typical workload classes [symbol] 102 and system configurations [symbol] 104. Telemetry data Rᵢ^{j}, in the format of multi-channel time series, may then be collected 106 from executions of workloads of those classes under those configurations. A set [symbol] of execution results may be subject to an aggregation 107 of executions of workloads of a same class under a same system configuration. A Riemannian normative model Mᵢ^{j} may then be trained 108 for each pair of configuration Cᵢ and workload class Wⱼ. These models may then be pruned 110 to eliminate any degenerate models, and thereby obtain 111 a set of non-degenerate models [symbol] . In an embodiment, this may conclude the offline stage.

At the online stage, the resulting set of non-degenerate models [symbol] may then be deployed 112 with a new system S with known configuration S_{C}. As telemetry data S_{R}, in similar format to that of Rᵢ^{j}, is collected 114 at system S, an embodiment may assess 115 the normalcy of the current window of data wₜ with multiple models. These models may be filtered 116, such that only models Mᵢ of configurations Cᵢ that are similar to S_{C} are considered. The assessments 115 may result in scores, which may be normalized 118 to account for variations in the sensitivity of the Riemannian models. From the set of normalized scores sᵢ^{j} the best-scoring models may be determined 120. Those may be taken as an indication 122 of the current workload class Wⱼ currently executed in S. An embodiment may then provide a system configuration recommendation 124 based on the workload class change.

### C.1 Offline stage

### C.1.1 Workload Executions

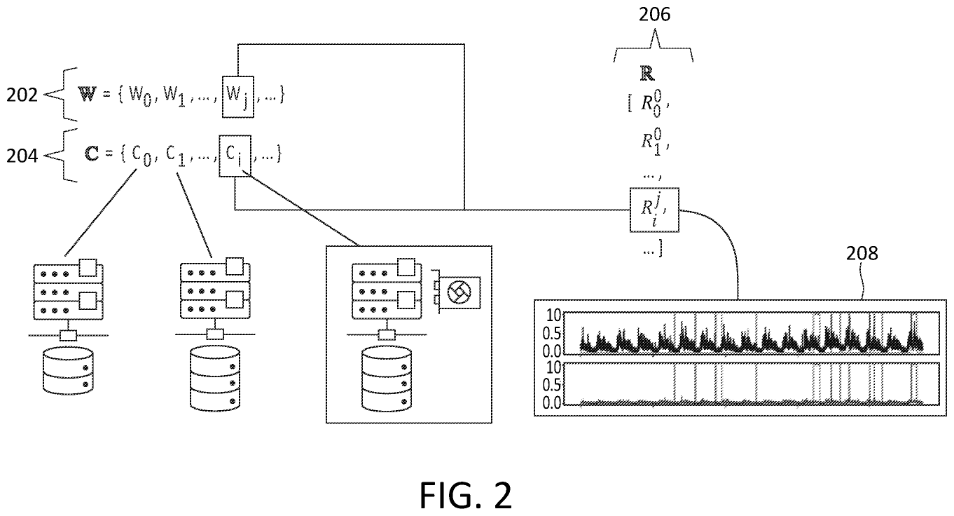

From workloads, belonging to known workload classes [symbol] 202 and system configurations classes [symbol] 204 an embodiment may obtain workload executions. This is disclosed in FIG. 2. Particularly, FIG. 2 discloses workload classes [symbol] 202 and system configuration classes [symbol] 204. A set of executions [symbol] 206 of workloads of each class under each system configuration is also disclosed.

In an embodiment, a database may be provided of known workload classes [symbol] , categorized according to known classes W1, W2, . . . . Some example workload classes include machine learning workloads, sequential data processing workloads, and audio signal compression workloads. The scope of the invention is not limited to the use or execution of any particular type or combination of workloads. Further, the set [symbol] 204 comprises known system configurations C1, C2 . . . , each of which may comprise respective system level information of a typical deployment of computational infrastructure at a customer site. These configurations may typically correspond to ‘standard’ or template offering by a vendor, such as Dell for example. In an embodiment, the execution results [symbol] 206 may comprise a set of timeseries data, wherein each Rᵢ^{j}∈ [symbol] is a multi-channel series 208 of telemetry data captured from a system with configuration Cᵢ while executing a workload of class Wⱼ. These may typically correspond to the telemetry data captured for other purposes in systems such as storage arrays, and therefore, an embodiment may not impose any additional computational burden, at least insofar as telemetry gathering is concerned.

As note earlier with respect to FIG. 1, the set [symbol] may be subject to an aggregation of executions of workloads of a same class under a same configuration. That is, if more than a single time series Rᵢ^{j} is available, an embodiment may consider that those series may be aggregated. Alternatively, and as described in the next section, an embodiment may account for those multiple series in the training of Riemannian normative models, and may train one independent model for each. If the latter is the case, and the multiple series Rᵢ^{j} are similar, all but one of the models would end pruned, as discussed elsewhere herein. An embodiment may abstract the environment necessary to run these workloads and collect this data, and may also leverage data generated at actual customer or deployed facilities if it is available. As an example of the latter, data may be collected by CloudIQ and aggregated at Dell.

### C.1.2 Riemannian Normative Models

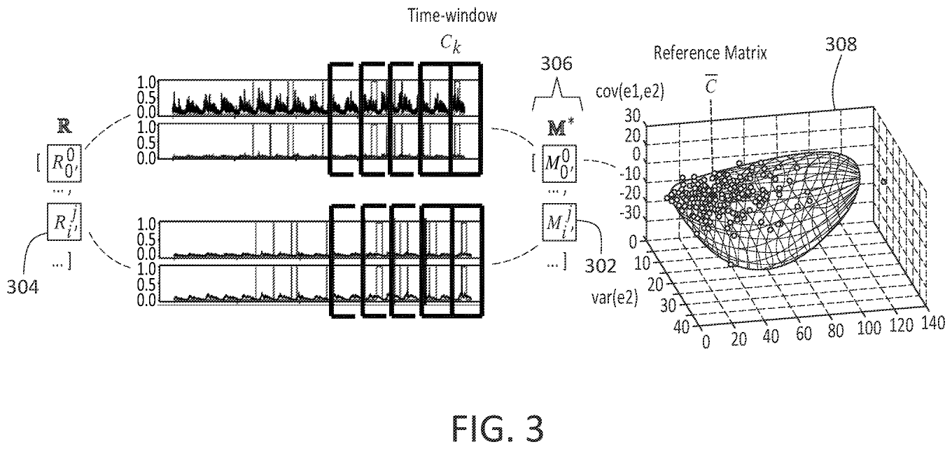

An embodiment may obtain a Riemannian Potato model for each pair i, j of array configuration Cᵢ and workload class Wⱼ. This is shown in FIG. 3. In particular, FIG. 3 discloses models Mᵢ^{j} 302 generated from all executions 304 of Rᵢ^{j}∈ [symbol] collected as a set [symbol] * 306. A visual representation 308 for the two-dimensional covariance matrixes in the example is also disclosed in FIG. 3. In general, an embodiment may determine a set [symbol] * 306 to hold all these models.

The process of defining each model M was described above. However, the time-windowed sample covariance matrices are considered as data descriptors, and each of them can be seen as a point living on a smooth manifold (SPD(n)). An embodiment may endow this manifold with a Riemannian metric at each tangent space so as to obtain a Riemannian manifold and its corresponding distance function, which reflects the underlying structure of that space.

The characteristics of the Riemannian Potato model may be desirable for this approach because it provides an anomaly detection method that is fast in training and inference and does not require annotated data. More importantly, as observed empirically during studies conducted by the inventors, this technique is highly sensitive to shifts in data distribution, making it a good indicator of data drift once its performance degrades. Finally, differently from other state-of-the-art techniques such as Matrix Profile, the Riemannian Potato achieves good performances even with multi-channel data. This offline process may have little to no impact on the functionality of actual systems.

### C.1.3 Pruning of Degenerate Models

Because not all workloads may be adequate for all types of systems configurations, degenerate models may be generated, that is, models that would either identify all, or most, behavior as anomalous, and/or models that would assign no, or virtually none, behavior as anomalous, and/or or models with overlapping manifolds “potatoes.” Hence, an embodiment may comprise a process to detect and prune the degenerate models from [symbol] * and generate a resulting set of non-degenerate models [symbol] .

A pruning procedure may begin after all the training is complete and the full set of [symbol] * has been obtained. In an embodiment, the pruning procedure may comprise two sequential pruning phases, the first phase looks to remove any potato that is too large or too small, and the second phase removes overlapping potatoes with high intersection.

During the first phase, the large and small models may be detected by measuring the Riemannian volume for all potatoes in [symbol] *. It may be expected that only a few models should produce an extreme large or extreme small potato. Therefore, any statistical technique that performs outlier removal based on the volume data should be adequate to prune these models.

The second phase uses the reference matrix C̅ and the defined potato threshold to grasp the potato size and calculate the intersection over union against nearby potatoes. Any potatoes with overlap exceeding a specified threshold, such as 80% or more for example, may be pruned from [symbol] *. In an ideal scenario, the pruning procedure may create a disjointed potato space for [symbol] , which indicates the workloads and models are highly separable, improving workload profiling.

### C.2 Online Stage

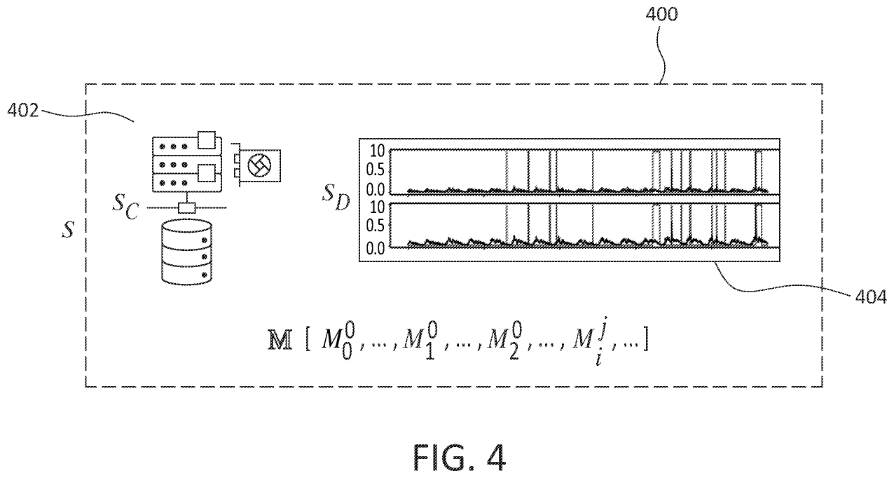

An embodiment may assume that the resulting set [symbol] of Riemannian models is deployed along with a new system S under consideration. This is depicted in FIG. 4, which discloses a representation 400 of a deployed system S. In an embodiment, these models may be small, since they can be described by only three parameters, which are the reference covariance matrix C̅ ∈ [symbol] [symbol] ^{x} [symbol] , the mean μ∈ [symbol] , and the standard deviation σ∈ [symbol] of the distance to it in the training set.

It is noted that, in an embodiment, the size of the models does not change with the size, or number of samples, of the time series used to generate the model. Rather, the size of the model relates to the number of channels in the time series. For instance, for the case where N=4, these parameters together amount to 408B. Therefore, on average, the size of the model may be expected to impose only negligible additional storage requirements at the system S, in addition to other requirements by management and orchestration software.

With continued reference to the example of FIG. 4, the configuration of the system is known—denoted as S_{C} 402. In this stage, an embodiment may perform a model scoring process which may enable the determination of a likely profile, or workload class, for the current workload S_{D} 404. The identified likely workload class may then be leveraged to determine a configuration recommendation for the system S_{C} 402.

### C.2.1 Model Scoring

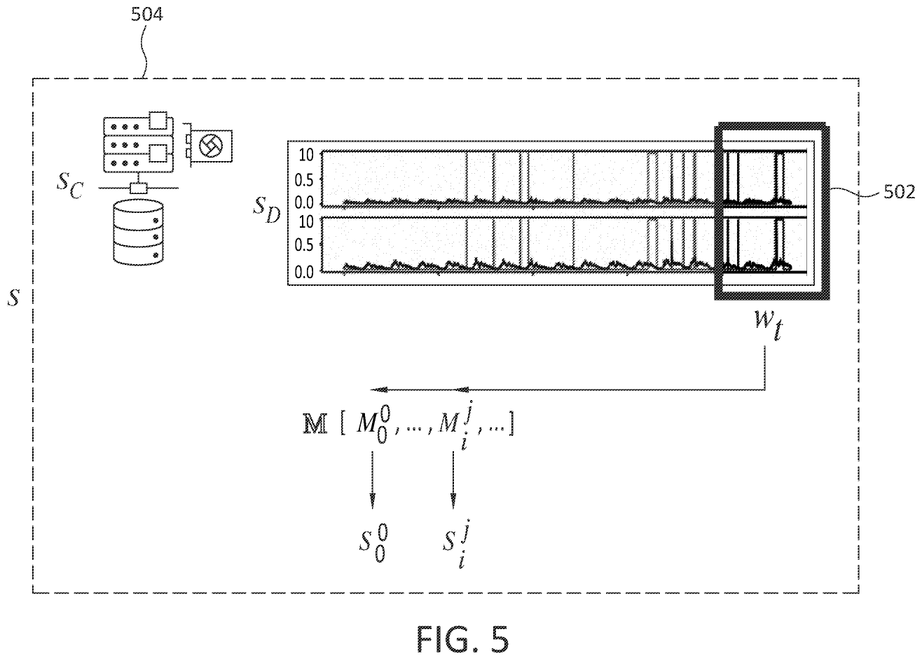

In an embodiment, telemetry information may be collected concerning the operation of the system. An embodiment may leverage the most-recent time-window of the telemetry series wₜ. The Riemannian models obtained in the offline stage may be used in a similar fashion to the online-anomaly detection approach, as defined by the Riemannian Potato approach, discussed earlier herein. This may be done with respect to each such model. This is represented in FIG. 5. Particularly, FIG. 5 discloses the most recent window wₜ 502 of telemetry data captured from system S 504, that has configuration C_{S}. This capture telemetry data may then be applied to each model Mᵢ^{j} independently.

Briefly, an embodiment may compare the current window of telemetry data with each ‘potato’ model. The anomaly detection performed is again according to the approach set forth earlier herein. It is worthwhile to note that this is an efficient step, computationally negligible, and does not impose a significant additional overhead to the system S. In one embodiment, the score sᵢ^{j} of model Mᵢ^{j} is the difference between that model anomaly threshold z and the model z-score over window wₜ. That is, the score sᵢ^{j} should be greater the more ‘certain’ the model is that the current window wₜ is normative. Since different models have different thresholds, an embodiment may later normalize these scores so they may be usefully compared to each other.

### C.2.1.1 Model Filtering

In this scoring approach, an embodiment may consider only models Mᵢ such that configuration Cᵢ is similar enough to S_{C}. This limits the approach with respect to the variation in system configuration that the approach may be able to suggest but, on the other hand, may ensure greater accuracy and coherence in the determination of the workload profile of S_{D}. As discussed below, an embodiment may comprise a mechanism to ignore the aforementioned tradeoff above by considering all models, that is, the embodiment may skip the filtering operation 116 in FIG. 1 before the assessment of the Riemannian normative models.

### C.2.1.2 Normalized Model Scores

In an embodiment, for each model, the obtained anomaly score may be divided by the potato surface area in order to normalize the scores. This yields a normalized score per potato model, that is, per workload class. This procedure may be performed so that different models, that is, ‘potatoes’ of different ‘sizes,’ are all set to a comparable score range of values. The normalized scores sᵢ^{j} are also represented in FIG. 5, with one obtained score sᵢ^{j} for the current window w for each model Mᵢ^{j}∈ [symbol] . The scores may then be used for the configuration recommendation decision, based on an estimated change in the profile of workloads under execution at the system S.

Recall that, as noted earlier herein, the models may have been filtered according to their relative, and respective, similarity with the configuration of the actual system S_{C}. In the case where the models have been filtered, an embodiment may compare the similarity between configuration Cᵢ and the configuration of the actual system S_{C} to obtain weighted scores.

### C.2.2 Configuration Recommendation Decision

It is noted that in an embodiment, the actual workload class being executed in a system may not be known, but it may be expected that the workload class corresponding to the workload actually being executed in that system will perform much better than workloads of other classes. With scores from multiple models at hand, and knowing that each model Mᵢ^{j} is uniquely related to the workload class Wⱼ, an embodiment may extrapolate the workload class most representative of S_{D} from the workload classes of the best-scoring models. That is, although it may not be known with certainty, an embodiment may score the models to determine what is the most likely workload class under execution.

### C.2.2.1 Current Workload Class

An embodiment may leverage this observation, determining a process to consider the resulting scores for establishing a configuration recommendation. One embodiment of the process may proceed as follows:
rank the scores and take the top n-th percentile—these may be referred to as the ‘top-normative scores,’ corresponding to ‘top-normative models’, for window Wₜ—note that the definition of n may be arbitrary, depending on the number of available models, and the number of models per configuration—in an embodiment, n may be at least equal to the average number of models respective to a same configuration;
determine the smallest score among the top-normative models as comparative threshold α;
group the scores sᵢ^{j} of the top-normative models by j by the workload class of the model Mᵢ^{j} yielding that score-particularly, for each group, compute the proportion of scores below a normative threshold α; and
obtain the group, corresponding to workload class, with the highest proportion, and determine the workload class from the group j—that is, Wⱼ, with j being the index of the group with a best proportion of scores above threshold.
   This process may thus yield an indication of the best-matching model Mᵢ^{j}(t) for S_{D}, considering the window wₜ.

### C.2.2.1 System Configuration Recommendation Based on Workload-Class Change

With the workload class indication obtained as described above, an embodiment may then perform an analysis of whether the workload class has changed. This may be important as a one-time configuration recommendation may not be ideal for actuation, since the ideal recommended configuration can vary from one window to the next.

In particular, an embodiment may assume that the results of the models—computed as discussed above, from previous windows denoted wₜ₋₁, wₜ₋₂, . . . , are available. One embodiment may proceed as follows.

An embodiment may consider the workload classes Wⱼ(t) and Wⱼ(t−1) of the models Mᵢ^{j}(t) and Mᵢ^{j}(t−1), respectively. If these workload classes are the same, it may be presumed that the workload class has kept the same, that is, the workload class is unchanged and the workload class under execution is the same as previously. In this case, an embodiment may compare the configuration Cᵢ(t) form the model Mᵢ^{j}(t) to the system S current configuration S_{C}. On the other hand, an embodiment may signal a recommendation of change to the system administrator or automation pipeline if Cᵢ(t) is sufficiently distinct from S_{C}.

This embodiment may consider only the current and previous models, from windows wₜ and wₜ₋₁. As a practical matter, multiple such indications may be required, especially if the window length is small. In that case, only a minimum of n repeated results of a model of configuration different to S_{C} could yield a recommendation of change.

In the opposite case, in which a model of another workload class has a best score, an embodiment may signal a workload profile change. Similar to the case above, this embodiment may instead keep a record of such changes to avoid brittle indications from fluctuations in the model scores, especially with smaller window sizes which may be more sensitive to outliers. A straightforward approach may be to keep a record of the number of indications of different workload and only trigger a recommendation after n repeated instances of the indications.

Regardless of the method, the approach indicates that the workload class has changed and presents an opportunity for adapting or offering a more appropriate alternative system configuration for execution of customer workloads. This approach may further provide a recommendation for the system configuration, corresponding to the configuration associated to the best scoring model for the previous, multiple, windows. The leveraging of this under different scenarios is discussed below.

### C.3 Leveraging System Configuration Recommendation

Changes in system configurations may reflect parametrization, and changes in tunable parameters for software-defined orchestration and management, such as cache policies for example, may be performed automatically, such as by feeding the results of the present approach into a pipeline of automatic adjustment procedures, or manually, such as by informing a specialist for further consideration of possible changes to a system configuration.

In an embodiment, the change in system configuration may also reflect a change in hardware capacity. This information may be fed into a aaS pipeline for extensible usage of resource, such as in mechanisms for elastic provisioning of resources. A recommendation may comprise a recommendation for a user specialist regarding ideal hardware upgrades, and/or enhancements or acquisitions for a current workload. These may inform the infrastructure planning for future deployments, for that customer.

A history of best-scoring models, which itself comprises a record of best matching configurations to workload classes, may inform the design of offerings to customers. This history may also help determine that certain configurations are subsumed by others in functionality, even if not in cost, and which workload classes are most commonly unanticipated by the sizing and provisioning prospects.

### D. Example Methods

It is noted with respect to the disclosed methods, including the example method of FIG. 1, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### E. Further Example Embodiments

Following are some further example embodiments of the invention. These are presented only by way of example and are not intended to limit the scope of the invention in any way.

Embodiment 1. A method, comprising: deploying a set of non-degenerate models to a system having a known configuration, wherein each of the non-degenerate models corresponds to a pair that comprises a system configuration and a workload class; running a workload on the system; collecting telemetry data generated as a result of the running of the workload; assessing the telemetry data with each of the non-degenerate models to generate a respective score for each of the models; identifying, as among the non-degenerate models, which of the non-degenerate models has a best score; and determining, based on the best score, whether or not a change is needed to hardware and/or software of the known configuration of the system.

Embodiment 2. The method as recited in any preceding embodiment, wherein one or more of the non-degenerate models comprises a respective trained Riemannian model.

Embodiment 3. The method as recited in any preceding embodiment, wherein the non-degenerate models were trained using known workloads and known system configurations.

Embodiment 4. The method as recited in any preceding embodiment, wherein the scores are normalized before the identifying of the non-degenerate model with the best score.

Embodiment 5. The method as recited in any preceding embodiment, wherein assessing the telemetry data comprises identifying a workload classification for the workload.

Embodiment 6. The method as recited in any preceding embodiment, wherein each of the non-degenerate models is configured to identify telemetry data that appears anomalous.

Embodiment 7. The method as recited in any preceding embodiment, wherein a workload class of the workload is unknown to the non-degenerate models.

Embodiment 8. The method as recited in any preceding embodiment, wherein the determining comprises identifying, as among the workload classes respectively associated with each of the non-degenerate models, which of the workload classes most likely corresponds to the workload.

Embodiment 9. The method as recited in any preceding embodiment, wherein when the determining indicates that a change is needed to the hardware and/or software, implementing the change to the hardware and/or software.

Embodiment 10. The method as recited in any preceding embodiment, wherein the determining is performed as-a-Service to a customer.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

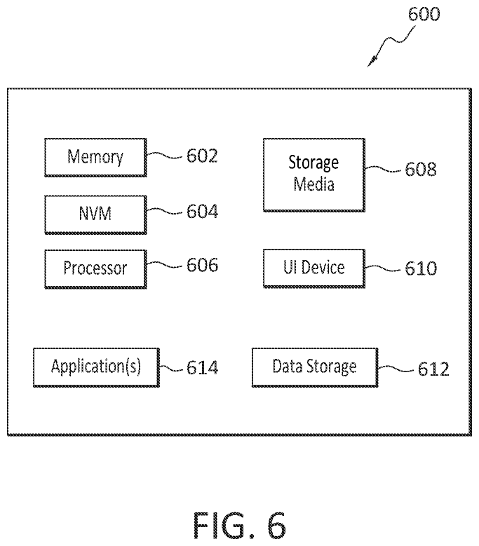

With reference briefly now to FIG. 6, any one or more of the entities disclosed, or implied, by FIGS. 1-5, and/or elsewhere herein, may take the form of, or include, or be implemented on, or hosted by, a physical computing device, one example of which is denoted at 600. As well, where any of the aforementioned elements comprise or consist of a virtual machine (VM), that VM may constitute a virtualization of any combination of the physical components disclosed in FIG. 6.

In the example of FIG. 6, the physical computing device 600 includes a memory 602 which may include one, some, or all, of random access memory (RAM), non-volatile memory (NVM) 604 such as NVRAM for example, read-only memory (ROM), and persistent memory, one or more hardware processors 606, non-transitory storage media 608, UI device 610, and data storage 612. One or more of the memory components 602 of the physical computing device 600 may take the form of solid state device (SSD) storage. As well, one or more applications 614 may be provided that comprise instructions executable by one or more hardware processors 606 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
deploying a set of non-degenerate models to a system having a known configuration, wherein each of the non-degenerate models corresponds to a pair that comprises a system configuration and a workload class;
running a workload on the system;
collecting telemetry data generated as a result of the running of the workload;
assessing the telemetry data with each of the non-degenerate models to generate a respective score for each of the models;
identifying, as among the non-degenerate models, which of the non-degenerate models has a best score; and
determining, based on the best score, whether or not a change is needed to hardware and/or software of the known configuration of the system.

2. The method as recited in claim 1, wherein one or more of the non-degenerate models comprises a respective trained Riemannian model.

3. The method as recited in claim 1, wherein the non-degenerate models were trained using known workloads and known system configurations.

4. The method as recited in claim 1, wherein the scores are normalized before the identifying of the non-degenerate model with the best score.

5. The method as recited in claim 1, wherein assessing the telemetry data comprises identifying a workload classification for the workload.

6. The method as recited in claim 1, wherein each of the non-degenerate models is configured to identify telemetry data that appears anomalous.

7. The method as recited in claim 1, wherein a workload class of the workload is unknown to the non-degenerate models.

8. The method as recited in claim 1, wherein the determining comprises identifying, as among the workload classes respectively associated with each of the non-degenerate models, which of the workload classes most likely corresponds to the workload.

9. The method as recited in claim 1, wherein when the determining indicates that a change is needed to the hardware and/or software, implementing the change to the hardware and/or software.

10. The method as recited in claim 1, wherein the determining is performed as-a-Service to a customer.

11. A non-transitory storage medium having stored therein instructions that are executable by one or more hardware processors to perform operations comprising:
deploying a set of non-degenerate models to a system having a known configuration, wherein each of the non-degenerate models corresponds to a pair that comprises a system configuration and a workload class;
running a workload on the system;
collecting telemetry data generated as a result of the running of the workload;
assessing the telemetry data with each of the non-degenerate models to generate a respective score for each of the models;
identifying, as among the non-degenerate models, which of the non-degenerate models has a best score; and
determining, based on the best score, whether or not a change is needed to hardware and/or software of the known configuration of the system.

12. The non-transitory storage medium as recited in claim 11, wherein one or more of the non-degenerate models comprises a respective trained Riemannian model.

13. The non-transitory storage medium as recited in claim 11, wherein the non-degenerate models were trained using known workloads and known system configurations.

14. The non-transitory storage medium as recited in claim 11, wherein the scores are normalized before the identifying of the non-degenerate model with the best score.

15. The non-transitory storage medium as recited in claim 11, wherein assessing the telemetry data comprises identifying a workload classification for the workload.

16. The non-transitory storage medium as recited in claim 11, wherein each of the non-degenerate models is configured to identify telemetry data that appears anomalous.

17. The non-transitory storage medium as recited in claim 11, wherein a workload class of the workload is unknown to the non-degenerate models.

18. The non-transitory storage medium as recited in claim 11, wherein the determining comprises identifying, as among the workload classes respectively associated with each of the non-degenerate models, which of the workload classes most likely corresponds to the workload.

19. The non-transitory storage medium as recited in claim 11, wherein when the determining indicates that a change is needed to the hardware and/or software, implementing the change to the hardware and/or software.

20. The non-transitory storage medium as recited in claim 11, wherein the determining is performed as-a-Service to a customer.
